(19) United States
(12) Patent Application Publication
(10) Pub. No.: US 2003/0123107 A1
(43) Pub. Date: Jul. 3, 2003

(54) Automatic document feeder for photographing devices

(76) Inventors: Thomas Sheng, Hsin Chu (TW); Youngs Wong, Hsin Chu (TW)

Correspondence Address: CHARLES E. BAXLEY, ESQUIRE, Hart, Baxley, Daniels & Holton, 5 Fl., 59 John St., New York, NY, 10038, US

(21) Appl. No.: 10/237,219

(22) Filed: Sep. 9, 2002

(30) Foreign Application Priority Data
Dec. 31, 2001 (TW) 090224841

(51) Int. Cl. H04N 1/04

(52) U.S. Cl. 358/498

(57) ABSTRACT

An automatic document feeder for photographing device which flattens the document and smoothes the process of the feed of the document. The automatic document feeder is cooperated with the document photographing device and comprises a document carrying device, a document feeding device, a document flattening device and a document output device. The document is sent to the document carrying device by the document feeding device and processed to be flat. The photographing device takes photograph for the document which is then sent out from the document output device. By this way, a good quality image can be obtained.

### FIELD OF THE INVENTION

The present invention relates to an automatic document feeder for a photographing device, and in particular to an automatic document feeder that makes the document to be flat.

### BACKGROUND OF THE INVENTION

Conventionally, it is able to use a scanner with a document feeder to get image information of a stack of documents. The speed of obtaining the image is limited because the scanner scans a two-dimensional object by a single dimensional sensor.

Therefore, a two-dimensional sensor has to be used to quickly get the image of the document. There is an existed device that takes photos of documents. The conventional way is to manually put a document on a photographing position and take a photo of the document. This is inconvenient for taking photos for a stack of documents.

Although those who have ordinary skills can easily combine conventional skills to use an automatic document feeder to feed documents to the photographing positions, they cannot obtain the best quality of image information if the document is not in a flat situation. For scanners, there are pressing plates or covers to flatten the document. On the contrary, for the photographing devices, there are no such assisting members to flatten the document. Although a piece of transparent glass can be used to press the document, reflection from the glass could affect the quality of photographing.

The invention provides an automatic document feeder for photographing devices and makes the document to be flat and also smoothes the processes of the feeding of the documents.

### SUMMARY OF THE INVENTION

The present invention provides an automatic document feeder for photographing devices and the purpose is to make the document to be flat before it is photographed.

The document is sucked by a force that makes the document to be flat and the force is generated by air or statistic electricity.

According to one aspect of the invention, there is provided an automatic document feeder which may be used together with a photographing device that gets image information from documents. The automatic document feeder includes a document carrying device which is located beneath the photographing device, a document feeding device which feeds a document into the document carrying portion, a document flattening device connected to the document carrying device and being used to flatten the document on the document carrying device, and a document output device which outputs the document.

By this way, the document sent to the document carrying device is flattened by the document flattening device so that it is benefit for obtaining an image information with good quality.

The present invention will become more obvious from the following description when taken in connection with the accompanying drawings which show, for purposes of illustration only, preferred embodiments in accordance with the present invention.

### BRIEF DESCRIPTION OF THE DRAWINGS

FIG. 1 shows a first embodiment of the automatic document feeder for a photographing device.

FIG. 2 shows another status of the first embodiment of the automatic document feeder for the photographing device.

FIG. 3 shows a second embodiment of the automatic document feeder for the photographing device, and

FIG. 4 shows a third embodiment of the automatic document feeder for the photographing device.

### DETAILED DESCRIPTION OF THE PREFERRED EMBODIMENTS

The first embodiment

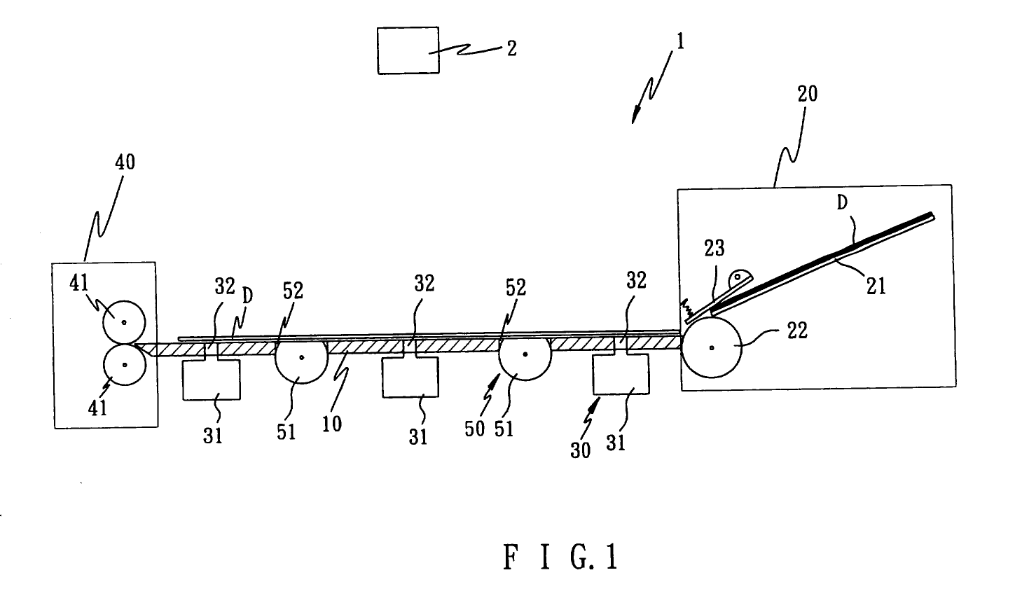

Referring to FIG. 1, the first embodiment of the automatic document feeder 1 is used with a photographing device 2 which obtains image information from the document. The document D to be photographed is sent to a photographing position by the automatic document feeder 1, and the document is photographed by the photographing device 2. When the process is finished, the automatic document feeder 1 sends the document D out and feeds another document to the above-mentioned photographing position.

The photographing device 2 can be a conventional camera, digital camera, video camera or digital video camera which can take flat photos.

The automatic document feeder 1 includes a document carrying device 10, a document feeding device 20, a document flattening device 30 and a document output device 40.

The document carrying device 10 is located beneath the photographing device 2 and can be installed in horizontal direction or inclined toward the document output device 40. The function that the declination of the document carrying device 10 is described hereinafter.

The document feeding device 20 is used to send the document D into the document carrying device 10. Generally, the document feeding device 20 includes a feeding cassette 21 and a plurality of documents D are put on the feeding cassette. It is to be noted that the document D and the document feeding cassette 21 are not show in full view. The document feeding device 20 includes a feeding roller 22 and a dividing plate 23 which is pressed onto the feeding roller 22 so that the documents D can be fed into the document carrying device 10 one by one.

The document flattening device 30 is connected to the document carrying device 10 and flattens the document D on the document carrying device 10. Therefore, the document flattening device 30 uses a sucking/blowing device 31 which is cooperated with multiple apertures 32 (circular holes, rectangular holes or slits) to flatten the document D. After the document D is fed to the document carrying device 10, the document D is processed to be flat by the document flattening device 30 and taken photograph by the photographing device 2 to have a good quality of two dimensional image information.

The document output device 40 includes output rollers 41 which feed out the document D. After the image information is taken, the document D is moved from the document carrying device 10 so that a following document D can be fed. Therefore, the document D has to reach the output rollers 41 of the document output device 40.

In order to let the document D contact the output rollers 41, one way that the embodiment uses is to move the document D toward the output rollers 41. Therefore, the automatic document feeder 1 further comprises a document moving device 50 which moves the document D on the document carrying device 10 toward the document output device 40. The document moving device 50 is composed of two cams 51 which are rotatably engaged with two holes 52 in the document carrying device 10. The number of the cam(s) 51 and the hole(s) 52 can be one or more than two. In FIG. 1, the flat surface of the cam 51 is flush with the document carrying device 10 such that the document D on the document carrying device 10 will not be interrupted.

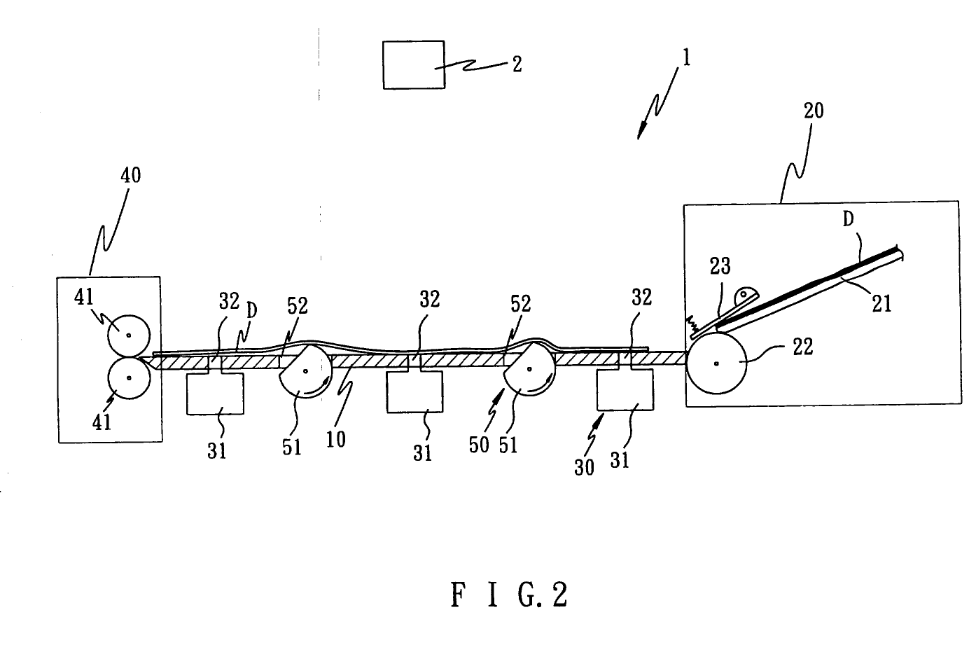

Referring to FIG. 2, when the document D is moved toward the document output device 40, the cams 51 are rotated in the direction indicated by the arrow head. By the friction between the document D and the cams 51, the document D is moved toward the document output device 40. Once the document D contacts the output rollers 41, the document D is then output from the document cassette (not shown) or other container receiving the document D. When the cams 51 finish their job, the flat surface of the cams 51 will be flush with the document carrying device 10 and then the next document D is ready to be taken.

Another way to let the document D contact the output rollers 41 is to use declined document carrying device 10 which allows the document D to slide toward the output rollers 41 by the gravity after the document flattening device 30 is disabled. In this way, the document does not need to move and the details will be described hereinafter.

There are many ways to let the document D contact the output rollers 41, for example, the apertures 32 are made to be inclined upward and toward the document output device 40. In this situation, the sucking/blowing device 31 shuts off the sucking function and blows air to the document D toward the document output device 40.

The second embodiment

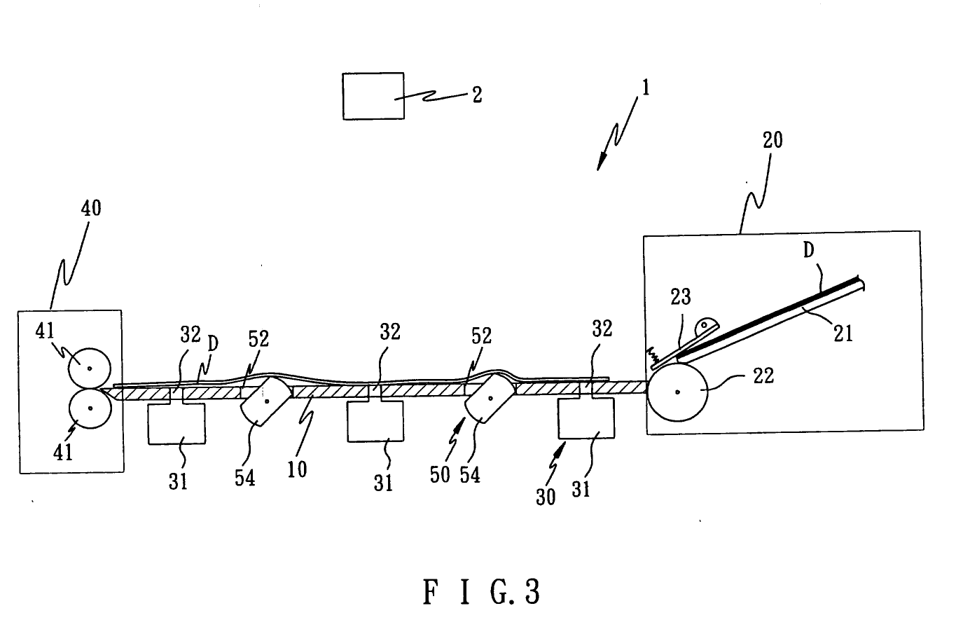

Referring to FIG. 3, the automatic document feeder of the second embodiment comprises a document carrying device 10, a document feeding device 20, a document flattening device 30, a document output device 40 and a document moving device 50. In this embodiment, the document carrying device 10, the document feeding device 20, the document flattening device 30, and the document output device 40 are the same as those in the first embodiment and which will not be described.

The difference between the first embodiment and the second embodiment is that the document moving device 50 can be composed of two shifting rods 54 which are movably engaged with the two apertures 52 in the document carrying device 10. The two shifting rods 54 have the same function as the cams 51 in the first embodiment.

The third embodiment

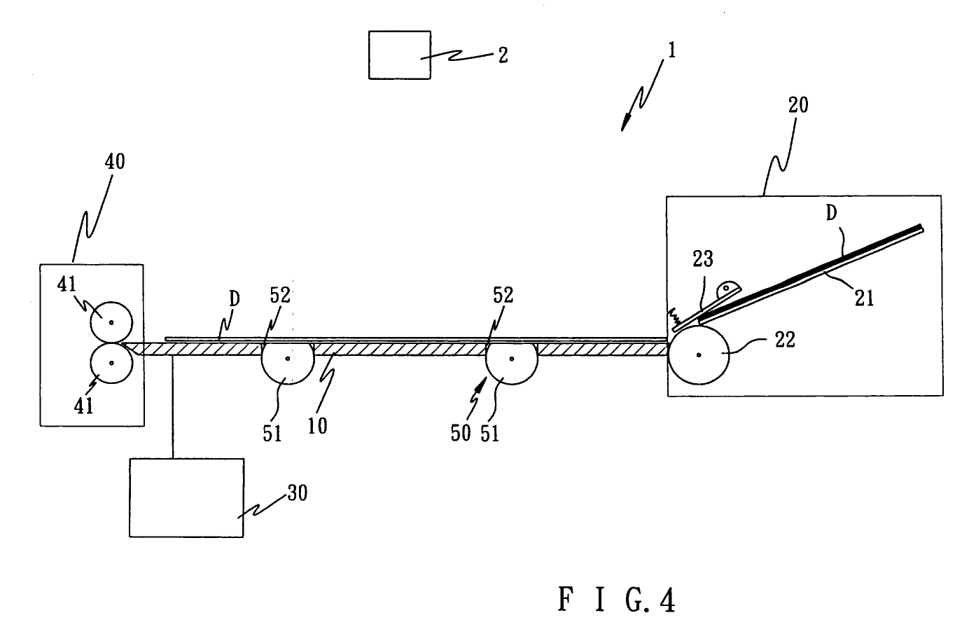

Referring to FIG. 4, the automatic document feeder of the third embodiment comprises a document carrying device 10, a document feeding device 20, a document flattening device 30, a document output device 40 and a document moving device 50. In this embodiment, the document carrying device 10, the document feeding device 20, the document flattening device 30, and the document moving device 50 are the same as those in the first embodiment and which will not be described.

The difference between the first embodiment and the third embodiment is that the function of the document flattening device 30 can be achieved by using statistic electricity which sucks the document so that the document flattening device 30 is a statistic electricity generating device which transfers the statistic electricity to the document carrying device 10 to suck and flatten the document.

No matter the document flattening device 30 uses statistic electricity or sucks air to flatten the document, it is to be noted that before the document moving device 50 moves the document, users may optionally choose to shut off or turn down the function of the document flattening device 30 to allow the document to be moved.

Because the required sizes that the users need may vary, the automatic document feeder of the present invention may be adjusted according to the sizes of the document.

In order to achieve the above mentioned purpose, the distance between the document feeding device 20 and the document output device 40 can be set to be adjustable. For instance, the document carrying device 10 can be designed to be moved horizontally.

It is to be noted that the document output device 40 may only include the document cassette or the document container (not shown) without the output rollers 41.

In order to achieve the above mentioned functions, the document carrying device 10 can be declined toward the document output device 40. In the amended arrangement, the document D moves toward the output device 40 by the gravity and the document moving device 50. In another way, only by the gravity, the document D moves toward the document output device 40 without the document moving device 50.

While we have shown and described the embodiments in accordance with the present invention, it should be clear to those skilled in the art that further embodiments may be made without departing from the scope of the present invention.

What is claimed is:

1. An automatic document feeder cooperated with a document photographing device which is used to obtain image information from the document, the automatic document feeder comprising:
a document carrying device located beneath the document photographing device;
a document feeding device for feeding the document into the document carrying device;
a document flattening device connected to the document carrying device and flattening the document on the document carrying device; and
a document output device for sending the document out.

2. The document feeder cooperated with a document photographing device as claimed in claim 1, further comprising a document moving device which moves the document on the document carrying device toward the document output device.

3. The document feeder cooperated with a document photographing device as claimed in claim 1, wherein:
the document carrying device is formed with at least one hole; and
the document moving device includes at least one cam which is rotatably engaged with the at least one hole.

4. The document feeder cooperated with a document photographing device as claimed in claim 1, wherein:
the document carrying device is formed with at least one hole; and
the document moving device includes at least one shifting rod which is rotatably engaged with the at least one hole.

5. The document feeder cooperated with a document photographing device as claimed in claim 1, wherein the document flattening device comprises:
a plurality of apertures penetrating through the document flattening device; and
a sucking/blowing device which communicates with the apertures so as to suck through the apertures and to flatten the document.

6. The document feeder cooperated with a document photographing device as claimed in claim 5, wherein the sucking/blowing device blows air through the apertures so as to move the document toward the document output device.

7. The document feeder cooperated with a document photographing device as claimed in claim 1, wherein the document flattening device comprises a statistic electricity attraction device which sucks and flat the document by using statistic electricity.

8. The document feeder cooperated with a document photographing device as claimed in claim 1, wherein the document feeding device comprises a feeding roller and a document dividing plate which presses onto the feeding roller.

9. The document feeder cooperated with a document photographing device as claimed in claim 1, wherein the document output device comprises a document output roller.

10. The document feeder cooperated with a document photographing device as claimed in claim 1, wherein a distance between the document feeding device and the document output device is adjustable.

11. The document feeder cooperated with a document photographing device as claimed in claim 1, wherein the document carrying device is declined toward the document output device.

12. The document feeder cooperated with a document photographing device as claimed in claim 3, wherein the cam has at least one flat surface.
